(19) United States
(12) Patent Application Publication
(10) Pub. No.: US 2005/0011042 A1
(43) Pub. Date: Jan. 20, 2005

(54) Self-cleaning handle

(76) Inventors: Vernon Hupp, Penticton (CA); Shirley Alice Hupp, Penticton (CA); Eric A. Matheson, Oliver (CA)

Correspondence Address: ANTONY C. EDWARDS, SUITE 800 - 1708 DOLPHIN AVENUE, KELOWNA, BC, V1Y 9S4, CA

(21) Appl. No.: 10/889,040

(22) Filed: Jul. 13, 2004

Related U.S. Application Data
(60) Provisional application No. 60/486,421, filed on Jul. 14, 2003.

(51) Int. Cl. E05B 1/00

(52) U.S. Cl. 16/110.1

(57) ABSTRACT

The present invention relates to a self-cleaning handle. The handle includes a member having a user contact portion, the member and a fluid applicator housing being biased towards a default position and moveable from the default position to an actuated position by a user applying a force to the user contact portion. The handle also includes a fluid applicator having a fluid release portion disposed between the member and the fluid applicator housing wherein the fluid applicator is in contact with the user contact portion. The member is rotatable with respect to the fluid applicator housing. The handle also includes a rotator connected to the member to rotate the member upon release of the member from its actuated position such that the fluid release portion applies fluid to the user contact portion of the member and a sanitized user contact portion is available for the next user.

### CROSS REFERENCE TO RELATED APPLICATION

This application claims priority from U.S. Provisional Patent Application No. 60/486,421 filed Jul. 14, 2003 entitled SELF-CLEANING HANDLE.

### FIELD OF THE INVENTION

This invention relates to the field of handles, and more particularly, it relates to a self-cleaning handle.

### BACKGROUND OF THE INVENTION

Handles are generally defined as the part by which various articles are held, carried or controlled. The nature of many types of handles, such as door handles and the like, requires that the handles are repeatedly contacted by different users. Door handles for public restrooms and other public places are particularly vulnerable to repeated contact by multiple users, as persons enter and exit through such doors. Such handles inevitably become contaminated through contact with individuals who may use less than adequate care in maintaining their hands free from dirt, germs and other contaminants. This is particularly worrisome in places such as hospitals, restaurants, and offices, where the spread of disease due to inadvertent contact with a contaminated surface can pose a significant health hazard.

Attempts have been made to provide for handles which self-sanitize. For example, U.S. Pat. No. 4,939,812 to Bauer teaches a door handle having a slide which is moved along the length of a strap portion of the handle to sweep dirt and other contaminants from the strap portion.

One of the problems with such a handle is the requirement for a motor or any other drive mechanism to drive the slide along the handle.

U.S. Pat. No. 1,491,780 to Abbott discloses a handle adapted to hold substances capable of giving off a sanitizing and/or disinfecting emanation, vapour or mist. Because of the continual release of such substances, the substance emanation, vapour or mist will be used up relatively quickly and require additional costs to replace. Furthermore, such substances may have a negative effect on users, in terms of allergies or otherwise, when they contact such a handle. The use of irradiating and/or U.V. light to sterilize door knobs and handles has also been disclosed in U.S. Pat. No. 4,710,634 to Brookes and U.S. Pat. No. 3,314,746 to Millar. One of the difficulties associated with such systems is that they are not readily amenable for use in all situations because they require an electrical connection to the handle in order to operate.

Furthermore, the irradiating and/or U.V. light may have a negative effect on users. Another disadvantage of such systems is that they do not remove dirt or other large particle contaminants.

The spooling of a paper or towel material over the contact portion of the handle such that the user always contacts a clean paper or towel surface has also been described in U.S. Pat. No. 2,903,734 to Inman, U.S. patent No. 4,658,469 to Hawkins, and U.S. Pat. No. 4,997,139 to Menard. The difficulty with such systems is the continual need for new paper and/or clean towels, both of which put a strain on the environment and result in substantial waste.

Accordingly, what is required is a self-cleaning handle which is self activated, is not likely to significantly impact the user, may be easily used in any type of situation, and which does not put an undue strain on the environment or result in substantial waste.

### SUMMARY OF THE INVENTION

The above needs are met by providing a self-cleaning handle which allows for the application of a fluid to the contact portion of the handle upon a user exerting force on the handle such that the user always contacts a portion of the handle which has been cleaned and sanitized by the fluid since being touched by a previous user of the handle.

In accordance with one aspect of the invention, there is provided a self-cleaning handle comprising a member having a user contact portion and a fluid applicator housing wherein the member and the fluid applicator housing are biased towards a default position and moveable from the default position to an actuated position when a user applies force to the user contact portion; a fluid applicator disposed between said member and said fluid applicator housing wherein the member is rotatable with respect to the fluid applicator housing; and a rotator connected to the member to rotate the member upon release of the member from its actuated position such that the fluid release portion applies fluid to the user contact portion of the member.

Opposite first and second ends of the member are rotatably coupled with a first end of, respectively, a top plate and a bottom plate such that the member may rotate 360°. A first end and a second end of the fluid applicator housing is also coupled with the first end of the top and bottom plates. A second end of the top and bottom plates are pivotally coupled to a mounting plate as substantially a parallelogram such that movement of the member and the fluid housing applicator between the default position and the actuated position pivots the top and bottom plates relative to the mounting plate.

A lower end of the fluid applicator is partially disposed within a fluid reservoir to draw the fluid from the fluid reservoir such that the fluid may be released onto the user contact portion, for example by contact between the applicator and member. The fluid reservoir may be detachably mountable to the bottom plate so as to be in fluid communication with the fluid applicator. The fluid applicator comprises an absorbent substance capable of releasably retaining the fluid.

The rotator may include a rack and pinion gear drive and a pawl and ratchet mechanism. The rack and pinion gear drive comprises a pinion wheel fixedly mounted to a first end of a drive shaft wherein the first end of the drive shaft projects from a top end of the member through a slider plate and into a horizontal passageway on the bottom of the top plate. The rack is coupled with a first side of the horizontal passageway such that rotation of the pinion wheel enables the drive shaft to guide the member and the fluid applicator housing along the horizontal passageway between the default position and the actuated position. The pawl and ratchet mechanism is attached to a second end of the drive shaft wherein the second end of the drive shaft is disposed within the upper end of the member. The pawl and ratchet mechanism comprises ratchets and pawls pivotally coupled with the drive shaft such that the pawls engage and latch into the ratchets only when the drive shaft rotates in a first direction. When the member moves from the actuated position to the default position, the pinion wheel rotates in a first direction causing the drive shaft to rotate in the first direction and thereby rotating the member in the first direction such that the user contact portion that was previously contacted by a user rotationally displaces to be in contact with the fluid applicator while a sanitized user contact portion rotates to become the user contact portion.

### BRIEF DESCRIPTION OF THE DRAWINGS

Having generally described the nature of the invention, preferred embodiments will now be described with reference to the accompanying drawings, in which:

FIG. 1 is a right side perspective view of a self-cleaning handle according to an embodiment of the present invention, shown in a default position;

FIG. 2 is a right side view of the self-cleaning handle as seen in FIG. 1;

FIG. 3 is a plan view of the self-cleaning handle as seen in FIG. 1;

FIG. 4 is a right side perspective view of the self-cleaning according to the embodiment seen in FIG. 1, shown in an actuated position;

FIG. 5 is a right side perspective view of the self-cleaning handle as seen in FIG. 4;

FIG. 6 is a plan view of the self-cleaning handle as seen in FIG. 4;

FIG. 7 is a side perspective view of the fluid applicator disposed between the housing and the drum; and

FIG. 8 is an enlarged, partially cutaway side perspective view of the rotator and the rack and pinion gear device cooperating to move the drum and the fluid applicator housing between the default position and the actuated position.

### DETAILED DESCRIPTION OF EMBODIMENTS OF THE INVENTION

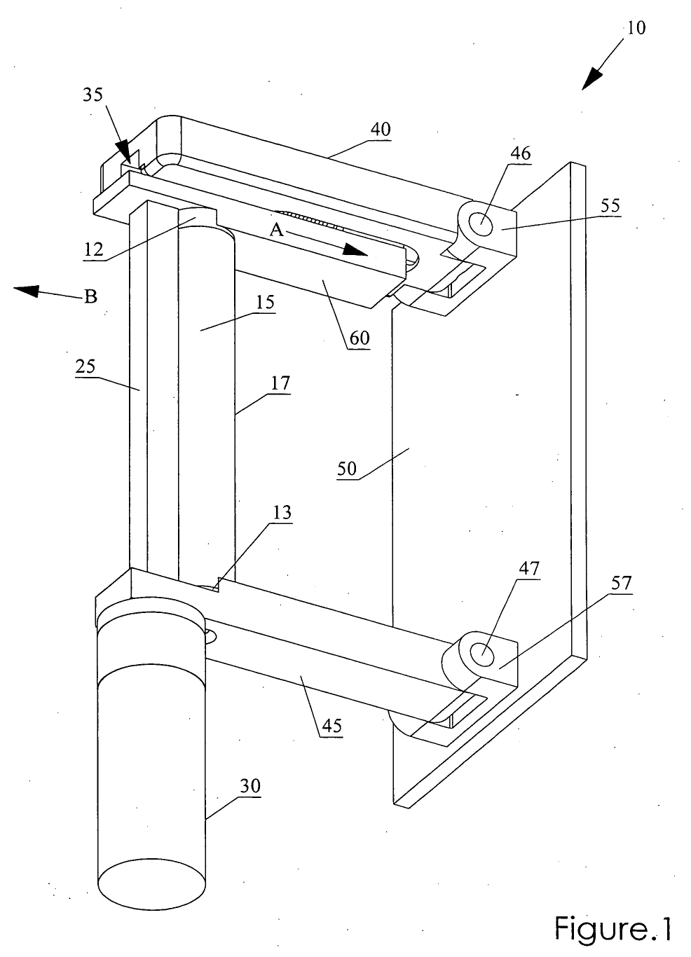

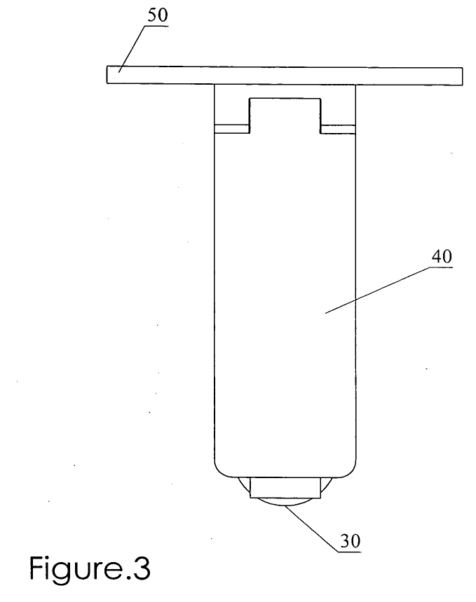

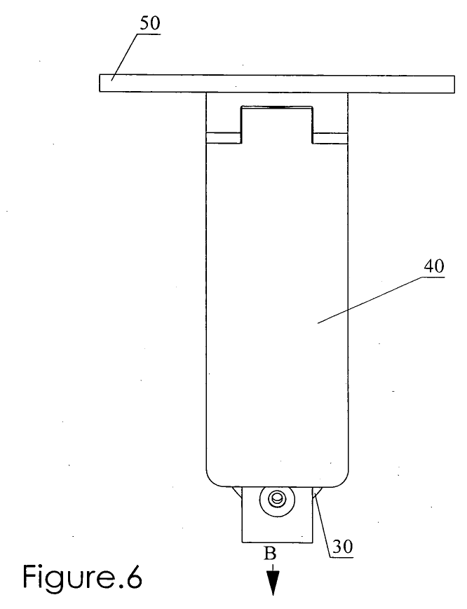

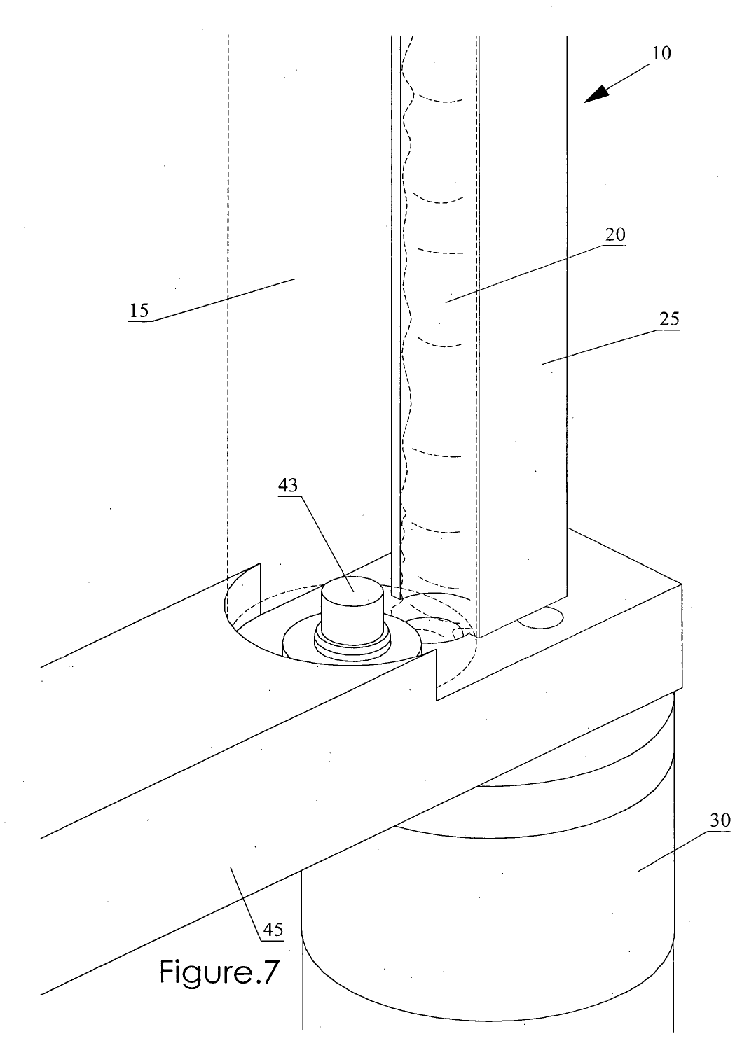

In the accompanying drawings FIGS. 1 to 8 wherein similar characters of reference denote corresponding parts in each view, a self-cleaning handle according to an embodiment of the present invention is shown generally at 10. Handle 10 comprises a member 15, a fluid applicator 20 disposed between a fluid applicator housing 25 and member 15, a fluid reservoir 30, and a rotator 35 for providing rotational movement of drum 15 relative to fluid applicator housing 25.

Handle 10 may be a door handle that allows a user to open and close the door. Similarly, handle 10 may be a handle to allow the opening and closing of a window, cabinet, drawer, or any other device having an open and closed position. Handle 10 may also be a handle used to lift an object such as a suitcase or briefcase or a handle used to control machinery. Handle 10 may be utilized for any number of applications wherein the user would prefer a clean and sanitary surface for contacting when using a handle, and wherein the self-cleaning handle of the present invention may be practically applied.

Member 15 may be any shape and/or size that will enable the present invention to operate as described herein. As seen in all the Figures, member 15 is preferably a cylindrical drum. As such, member 15 will also be referenced as drum 15 throughout this application. Drum 15 includes a user contact portion 17 wherein user contact portion 17 forms the parts of handle 10 with which the user will contact when operating handle 10. The embodiment shown in FIGS. 1 to 8 depict a handle operated by way of a pulling motion wherein user contact portion 17 includes the vertical length of drum 15 and extends around drum 15 on either side towards fluid applicator housing 25. Alternatively, if handle 10 is operated by way of a pushing motion, contact portion 17 may include fluid applicator housing 25. In a further alternative, if handle 10 is a lever type handle, user contact portion 17 may include the top and back of such lever. In another alternative where handle 10 is a door knob, contact portion 17 may include the entire circumferential surface area of such knob.

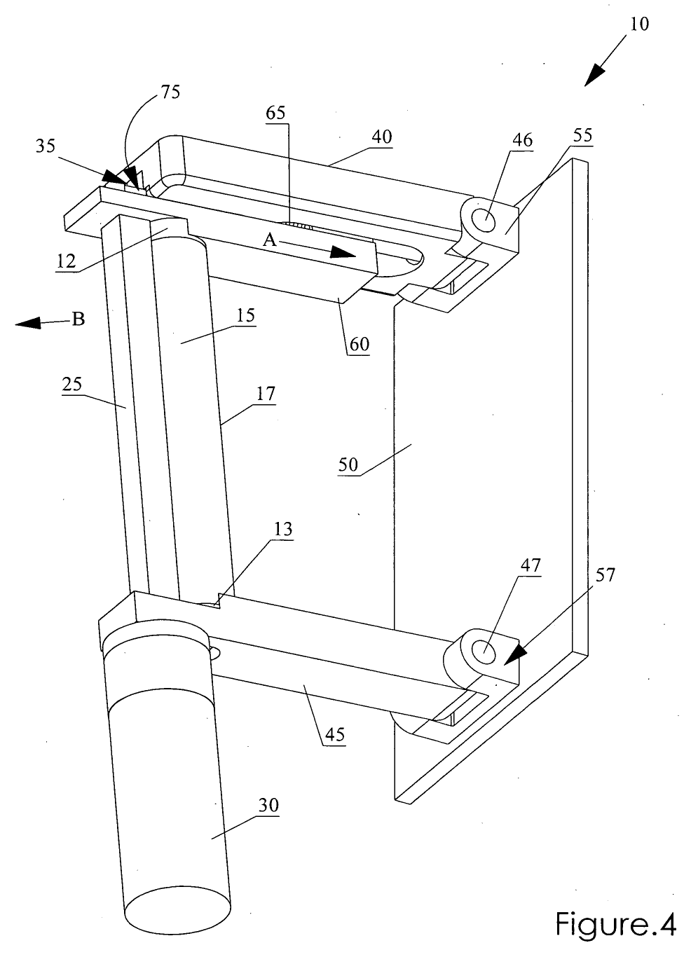

As will be appreciated, there are many different variations in which member 15 or drum 15 and fluid housing applicator 25 may move from a default position to an actuated position, depending on the embodiment of handle 10. As seen in FIGS. 1 to 8 wherein handle 10 is operated by way of a pulling motion, when drum 15 and fluid applicator housing 25 are biased in the default position, drum 15 and fluid applicator housing 25 are parallel to the longitudinal axis, as best seen in FIGS. 1 to 3. Drum 15 and fluid applicator housing 25 are moveable from the default position to the actuated position when the user applies force to pull on user contact portion 17. As seen in FIGS. 4 to 6, when drum 15 and housing 25 are moved into the actuated position, drum 15 and fluid applicator housing 25 are biased towards the user. Alternatively, where handle 10 is operated by way of a pushing motion, the default position of drum 15 and fluid applicator housing 25 would be the position seen in FIGS. 4 to 6 wherein drum 15 and fluid applicator housing 25 are biased towards the user and the actuated position would be the position seen in FIGS. 1 to 3 wherein drum 15 and fluid applicator housing 25 are parallel to the longitudinal axis. In the further alternative, where handle 10 is a lever handle, member 15 is pivotally attached in a parallel orientation to fluid applicator housing 25 such that a first end of member 15 pivots about a pivot point and a second end of member 15 travels in a circular arc, the default and actuated positions being at opposite ends of such an arc. In all the above-mentioned embodiments, when handle 10 is in the actuated position, the user may open a door, window, or any associated article or pick up or otherwise control the article to which handle 10 is connected with.

Handle 10 further comprises a top and a bottom plate 40 and 45 coupleable with a first and a second end 12 and 13 of drum 15. Top and bottom plate 40 and 45 are also coupleable with a first and second end of fluid applicator housing 25. First end 12 of drum 15 is rotatably coupleable with a first end of top plate 40 by a first axle point 42 and second end 13 of drum 15 is rotatably coupleable with a first end of bottom plate 45 by a second axle point 43 such that drum 15 may rotate 360°. A mounting plate 50 is pivotally coupleable with a second end of top and bottom plates 40 and 45 where the second ends of top and bottom plates 40 and 45 are opposite. Preferably, the second ends of top and bottom plates 40 and 45 pivot about a top and a bottom fulcrum 46 and 47 of a top and a bottom clevis 55 and 57. Top and bottom clevis 55 and 57 are mounted to mounting plate 50. Mounting plate 50 may be mounted by way of securing means known in the art, such a screws or bolts, to the article to which handle 10 is attached to, such as a door (not shown). It will be recognized that top and bottom plates 40 and 45 used to couple first and second ends 12 and 13 of drum 15 and first and second ends of fluid applicator housing 25 do not have to be in a top and bottom orientation. For example, the plates may be positioned in a side by side orientation, as would be the case if handle 10 is rotated such that drum 15 and fluid applicator housing 25 are parallel and horizontal. The present invention also contemplates the use of a single plate to rotatably couple only first end 12 of drum 15 adjacent first end of fluid applicator housing 25, such as in a lever handle.

Fluid applicator 20 is an elongated absorbent body that extends longitudinally along the length of drum 15. Preferably, fluid applicator 20 includes a wick that has a lower end that is partially disposed downwardly into the fluid within fluid reservoir 30 to draw or wick the fluid from fluid reservoir 30 upwardly to saturate fluid applicator 20. The lower end of fluid applicator 20 passes from fluid reservoir 30 through an aperture defined at the first end of bottom plate 45. Fluid applicator 20 extends the length of drum 15. Fluid applicator 20 is disposed between drum 15 and fluid applicator housing 25 such that fluid applicator 20 is in contact at all times with a partial surface of drum 15 to sanitize such partial surface. As drum 15 rotates as the handle is actuated, the partial surface becomes user contact portion 17 until it once again rotates into engagement with fluid applicator 20. In particular, as drum 15 and fluid applicator housing 25 move between the default position to the actuated position and back to the default position, rotator 35 rotates drum 15 such that user contact portion 17 that was previously contacted by the user rotationally displaces and becomes the partial surface that fluid applicator 20 is in contact with. Fluid applicator 20 releases cleaning and disinfecting fluids onto the partial surface to sanitize it for the next user to contact when drum 15 is rotated again. Simultaneously, when rotator 35 rotates drum 15, the partial surface that was previously in contact with fluid applicator 20 now becomes a sanitized user contact portion 17 for the next user. Other means for applying fluid from the fluid release portion of fluid applicator 20 onto drum 15 are also contemplated by the present invention. For example, the fluid may be sprayed or otherwise discharged from fluid reservoir 30 and/or fluid applicator 20 onto drum 15 and user contact portion 17.

Fluid applicator 20 has a fluid release portion formed generally from the point where the lower end of fluid applicator 20 extends through the aperture of bottom plate 45 to the upper end of fluid applicator 20 distal from the lower end. Fluid applicator 20 is in fluid communication with fluid reservoir 30 for providing fluid to the fluid release portion. The fluid release portion of fluid applicator 20 is adapted to release and apply fluid onto the partial surface of drum 15 that was previously user contact portion 17. Fluid applicator 20 may be made of any material capable of wicking and releasably retaining a fluid, such as, without intending to be limiting, an open-celled sponge or cord. It will be recognized that other types of absorbent substances may be used as fluid applicator 20 as long as they are able to wick or otherwise transfer fluid from fluid reservoir 30, and to store fluid for subsequent release onto the drum 15.

Fluid reservoir 30 may be threadably mounted below fluid applicator housing 25 for easy removal and replacement, so that fluid may be refilled when required. Alternatively, a new fluid reservoir may be provided to supply fresh fluid to fluid applicator 20 when required. Preferably, fluid reservoir 30 is detachably mountable to bottom plate 45. Alternatively top plate 40 or bottom plate 45 may also contain fluid. In the further alternative, fluid reservoir 30 may be detachably mountable to any other location which facilitates movement of the fluid to fluid applicator 20, such as top plate 40. Resilient seals which prevent leakage of excess fluid from fluid reservoir 30 to fluid applicator 20 may also be included, especially if fluid reservoir is detachably mountable to plate 40. The seals may be made of any resilient material such as rubber in order to provide the most effective sealing of the fluid. Alternatively, to prevent leakage, the aperture through which fluid applicator 20 passes from fluid reservoir 30 may be closed when drum 15 is in the default position and opened when drum 15 is in the actuated position to allow fluid to flow from fluid reservoir 30 into the fluid release portion of fluid applicator 20. It will be recognized that there are many different ways of providing fluid to the fluid applicator within the scope of the present invention.

Many different types of fluids designed to clean, disinfect, and/or otherwise sanitize user contact portion 17 may be used. In order to minimize the contact of the fluid with the user of handle 10, the fluid may be one which evaporates relatively quickly once released from the fluid release portion of fluid applicator 20, such that user contact portion 17 is not wet when contacted again by the user. A fluid having a greater viscosity maybe more suitable for certain embodiments of the invention to reduce the chance of leakage of the fluid out of the applicator.

Handle 10 may also be designed with a second user contact portion which allows a user of handle 10 to operate handle 10 without contacting user contact portion 17, in the event that a user, for example, has a sensitivity to the cleaning fluid. For example, fluid reservoir 30 may also act as a non-sterile user contact portion of handle 10 for users not wanting to contact the self-cleaning portion of handle 10.

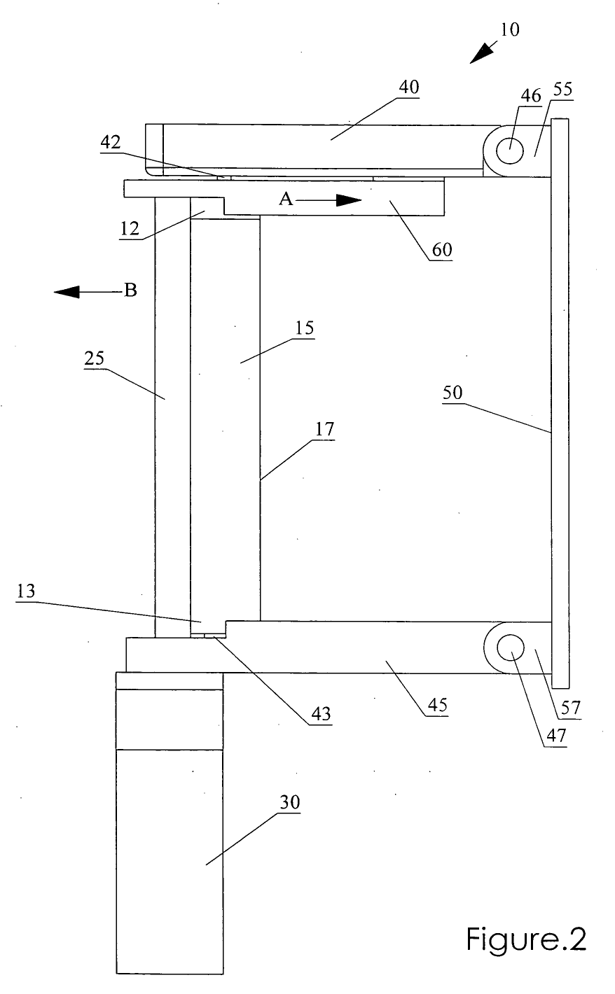

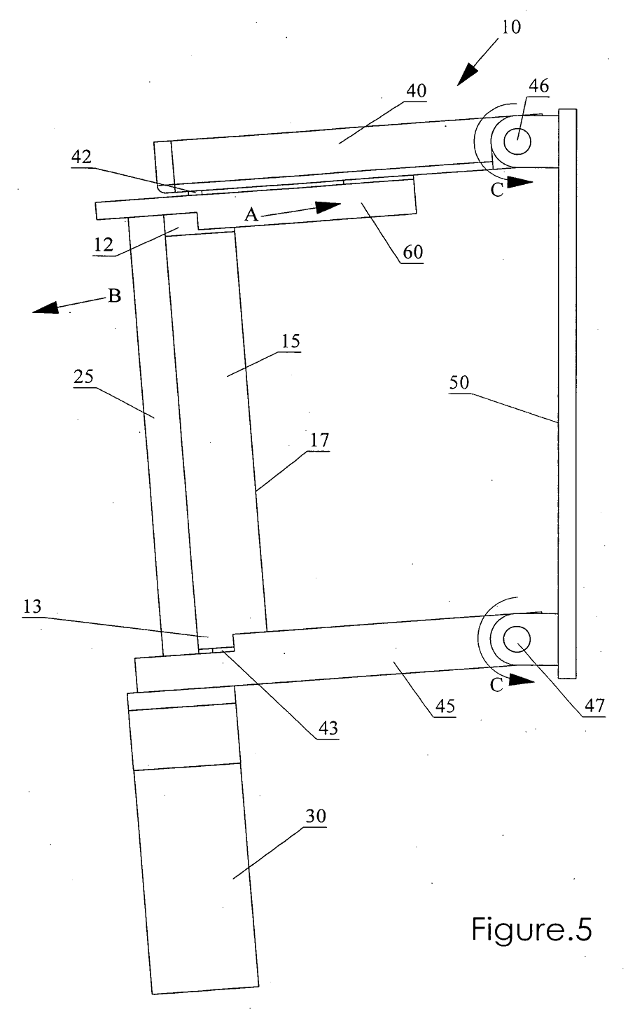

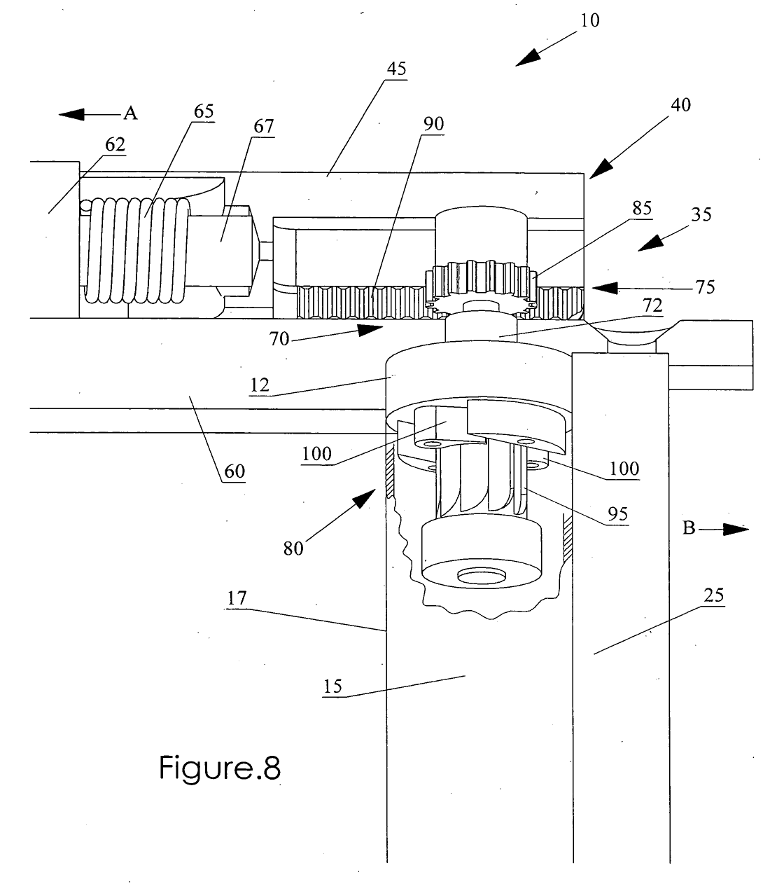

Referring to FIG. 8, rotator 35 comprises a rack and pinion gear drive 70 and a pawl and ratchet mechanism 80. Projecting from the top end 12 of drum 15 is a drive shaft 72 which is disposed partially within the upper portion of drum 15. Drive shaft 72 projects through a supporting slider plate 60 and into a horizontal passageway 75 in the bottom of top plate 40. Rack and pinion gear drive 70 is mounted in horizontal passageway 75 and guides drive shaft 72 and drum 15 along horizontal passageway 75 between the default and actuated positions of FIGS. 1 and 4, respectively. Horizontal passageway 75 defines a path having a first side for the operation of rack and pinion gear drive 70. A return spring 65 is also disposed within horizontal passageway 75. In the embodiment shown in FIG. 8, compressed return spring 65 urges drum 15 and fluid applicator housing 25 to return back in direction A to the default position when drum 15 and fluid applicator housing 25 are released by the user. Return spring 65 is biased against block 62 rigidly mounted to slider plate 60 to return drum 15 and fluid applicator housing 25 from the actuated position to the default position. Spring 65 may be a coil spring journalled on a shaft 67. Shaft 67 is mounted horizontally along. In the illustrated embodiment where the rotation of drum 15 is actuated by a pulling motion in direction B, as drum 15 and housing 25 are translated into the actuated position of FIGS. 4 and 5, top and bottom plates 40 and 45 rotate slightly in direction C about fulcrums 46 and 47, respectively, and simultaneously, plate 60 compresses spring 65. When the user releases handle 10, the spring expands, causing plate 60, drum 15, fluid applicator housing 25, and top and bottom plates 40 and 45 to return to the default position of FIGS. 1 and 2.

Rack and pinion gear drive 70 is comprised of a pinion wheel 85 fixedly mounted to a first end of drive shaft 72 and a rack 90 coupled with the first side of elongated horizontal passageway 75. When handle 10 is moved into the actuated position by a pulling motion in direction B, movement of drive shaft 72 when drum 15 and fluid applicator housing 25 are displaced causes pinion wheel 85 and drive shaft 72 to rotate in a counterclockwise direction D. When handle 10 is released and spring 65 moves drum 15 and fluid applicator housing 25 back into the default position, movement of drive shaft 72 when drum 15 and fluid applicator housing 25 are displaced causes pinion wheel 85 and drive shaft 72 to rotate in a clockwise direction E.

Attached to a second end of drive shaft 72 and disposed within the upper end of drum 15 is pawl and ratchet mechanism 80. Preferably, pawl and ratchet mechanism 80 comprises ratchets 95 and two pawls 100 pivotally coupled with the outer circumference of drum 15. Pawls 100 are biased towards drive shaft 72 by springs. When drive shaft 72 is rotated counter-clockwise, pawls 100 do not latch with ratchets 95, and drive shaft 72 rotates independently of drum 15. When drive shaft 72 is rotated in a clockwise direction, pawls 100 engage and latch into ratchets 95 and force drum 15 to rotate in a clockwise direction along with drive shaft 72. Therefore, as drum 15 is moved from the default position to the actuated position by a user, rack 90 rotates pinion wheel 85 in a counter-clockwise direction, which rotates drive shaft 72 in a counter-clockwise direction without transferring rotational movement to drum 15. Drum 15 therefore moves to the actuated position without rotating. However, when the user releases drum 15, spring 65 causes rack 90 to rotate pinion wheel 85 in a clockwise direction, which rotates drive shaft 72 in a clockwise direction as drum 15 is returned back to its default position. Drum 15 is also rotated clockwise by virtue of pawls 100 engaging ratchets 95 such that drum 15 is pulled along with drive shaft 72 from the actuated position to the default position. As drum 15 is rotated from the actuated to the default position, user contact portion 17 rotates clockwise in direction E past fluid applicator 20 within fluid applicator housing 25 such that fluid is applied to user contact portion 17 thereby cleaning user contact portion 17 upon each release of handle 10. User contact portion 17 may not be constantly in the same place on drum 15 but may change with each use of handle 10, if for example, movement of drum 15 from the actuated to default position results in less or more than 360 degrees of rotation. The present invention contemplates such a situation as long as user contact portion 17 contacted by the user in any given use of handle 10 receives an application of fluid from fluid applicator 20 before that portion is contacted by another user prior to another use of handle 10.

It will be recognized that there are many different mechanisms that can be used for rotating member 15 upon release of member 15 from the actuated position, and many different ways of biasing member 15 towards the default position. It is simply necessary that the mechanism permits non-rotary movement of member 15 between the default and actuated positions and rotary movement of member 15 in the opposite direction.

Given the number of mechanisms that may be at work within handle 10 when actuated by a user, it will be recognized that there must be provided sufficient force or resistance by the object to which handle 10 is connected with, or which handle 10 controls, such that handle 10 may be actuated only upon movement of drum 15 to an actuated position.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A self-cleaning handle comprising:
a member having a user contact portion;
a fluid applicator housing cooperating with said member such that said fluid applicator housing and said member are both biased towards a default position and moveable between said default position and an actuated position;
a fluid applicator disposed between said fluid applicator housing and said member such that said fluid applicator is in contact with said user contact portion; and
a rotator adapted to rotate said member when said member and said fluid applicator housing moves between said default position and said actuated position such that when said member rotates, said user contact portion of said member is sanitized by said fluid applicator and exposed for a user to contact.

2. The handle of claim 1 further comprising a top plate and a bottom plate wherein a first end of said member is rotatably coupled with a first end of said top plate and a second end of said member is rotatably coupled to a first end of said bottom plate such that said member may rotate 360°.

3. The handle of claim 2 wherein a first end of said fluid applicator housing is coupled with said first end of said top plate and a second end of said fluid applicator housing is coupled with said first end of said bottom plate.

4. The handle of claim 3 further comprising a mounting plate extending between said top and bottom plates wherein a second end of said top plate is pivotally coupled with a first end of said mounting plate and a second end of said bottom plate is pivotally coupled with a second end of said mounting plate such that movement of said member and said fluid applicator housing between said default position and said actuated position pivots said top and said bottom plate relative to said mounting plate.

5. The handle of claim 4 further comprising a fluid reservoir detachably mountable to said bottom plate wherein a lower end of said fluid applicator is partially disposed within said fluid reservoir so that said fluid reservoir is in fluid communication with said fluid applicator.

6. The handle of claim 5 wherein said fluid applicator includes means for drawing said fluid from said fluid reservoir releasably and retaining said fluid in said fluid application such that said fluid may be released onto said user contact portion.

7. The handle of claim 6 wherein said rotator comprises a rack and pinion gear drive and a cooperating pawl and ratchet mechanism.

8. The handle of claim 7 wherein said rack and pinion gear drive comprises:
a pinion wheel fixedly mounted to a first end of a drive shaft, said first end of said drive shaft projecting from a top end of said member through a slider plate and into a horizontal passageway, said horizontal passageway locatable in a bottom side of said top plate; and
a rack coupled with a first side of said horizontal passageway;
wherein rotation of said pinion wheel enables said drive shaft to guide said member and said fluid applicator housing along said horizontal passageway between said default position and said actuated position.

9. The handle of claim 8 wherein said pawl and ratchet mechanism is attached to a second end of said drive shaft, said second end of said drive shaft disposed within said upper end of said member.

10. The handle of claim 9 wherein said pawl and ratchet mechanism comprises ratchets and pawls pivotally coupled with said drive shaft such that said pawls engage and latch into said ratchets only when said drive shaft rotates in a first direction.

11. The handle of claim 10 wherein when said member moves from said actuated position to said default position, said pinion wheel rotates in said first direction causing said drive shaft to rotate in said first direction and thereby rotating said member in said first direction such that said user contact portion that was previously contacted by a user rotationally displaces to be in contact with said fluid applicator while a sanitized user contact portion rotates to become said user contact portion.

12. The handle of claim 11 further comprising a return spring disposed in said horizontal passageway, said return spring for urging said member and said fluid applicator housing to return to said default position.

13. A self-cleaning handle comprising:
a member having a user contact portion;
a fluid applicator housing cooperating with said member such that said fluid applicator housing and said member are both biased towards a default position and moveable between said default position and an actuated position;
a fluid applicator disposed between said fluid applicator housing and said member such that said fluid applicator is in contact with said user contact portion;
a fluid reservoir detachably mountable to said bottom plate wherein a lower end of said fluid applicator is partially disposed within said fluid reservoir, said fluid reservoir in fluid communication with said fluid applicator;
a rack and pinion gear drive; and
a pawl and ratchet mechanism;
wherein said rack and pinion gear drive cooperates with said pawl and ratchet mechanism so as to rotate said member when said member and said fluid applicator housing moves between said default position and said actuated position such that when said member rotates, said user contact portion of said member is sanitized by said fluid applicator and exposed for a user to contact.

14. The handle of claim 13 further comprising a top plate and a bottom plate wherein a first end of said member is rotatably coupled with a first end of said top plate and a second end of said member is rotatably coupled to a first end of said bottom plate such that said member may rotate 360°.

15. The handle of claim 14 wherein a first end of said fluid applicator housing is coupled with said first end of said top plate and a second end of said fluid applicator housing is coupled with said first end of said bottom plate.

16. The handle of claim 15 further comprising a mounting plate extending between said top and bottom plates wherein a second end of said top plate is pivotally coupled with a first end of said mounting plate and a second end of said bottom plate is pivotally coupled with a second end of said mounting plate such that movement of said member and said fluid applicator housing between said default position and said actuated position pivots said top and said bottom plate relative to said mounting plate.

17. The handle of claim 16 wherein said rack and pinion gear drive comprises:
a pinion wheel fixedly mounted to a first end of a drive shaft, said first end of said drive shaft projecting from a top end of said member through a slider plate and into a horizontal passageway, said horizontal passageway locatable in a bottom side of said top plate; and
a rack coupled with a first side of said horizontal passageway;
wherein rotation of said pinion wheel enables said drive shaft to guide said member and said fluid applicator housing along said horizontal passageway between said default position and said actuated position.

18. The handle of claim 17 wherein said pawl and ratchet mechanism is attached to a second end of said drive shaft, said second end of said drive shaft disposed within said upper end of said member.

19. The handle of claim 18 wherein said pawl and ratchet mechanism comprises ratchets and pawls pivotally coupled with said drive shaft such that said pawls engage and latch into said ratchets only when said drive shaft rotates in a first direction.

20. The handle of claim 19 wherein when said member moves from said actuated position to said default position, said pinion wheel rotates in said first direction causing said drive shaft to rotate in said first direction and thereby rotating said member in said first direction such that said user contact portion that was previously contacted by a user rotationally displaces to be in contact with said fluid applicator while a sanitized user contact portion rotates to become said user contact portion.

21. The handle of claim 2 wherein said top and bottom plates are substantially parallel and wherein said member and said fluid applicator housing are parallel and closely adjacent so as to contact said fluid applicator with said member and extend substantially orthogonally between said top and bottom plates.

22. The handle of claim 14 wherein said top and bottom plates are substantially parallel and wherein said member and said fluid applicator housing are parallel and closely adjacent so as to contact said fluid applicator with said member and extend substantially orthogonally between said top and bottom plates.

23. The handle of claim 4 wherein said top and bottom plates form substantially a parallelogram for said pivoting relative to said mounting plate.

24. The handle of claim 16 wherein said top and bottom plates form substantially a parallelogram for said pivoting relative to said mounting plate.
